(19) United States
(12) Patent Application Publication
(10) Pub. No.: US 2005/0113997 A1
(43) Pub. Date: May 26, 2005

(54) Electronically-controlled suspension apparatus and damping force control method

(75) Inventor: Wanil Kim, Kyonggi-do (KR)

Correspondence Address: BACON & THOMAS, PLLC, 625 SLATERS LANE, FOURTH FLOOR, ALEXANDRIA, VA, 22314, US

(73) Assignee: Mando Corporation, Kyonggi-do (KR)

(21) Appl. No.: 10/995,391

(22) Filed: Nov. 24, 2004

(30) Foreign Application Priority Data
Nov. 23, 2003 (KR) 10-2003-0084378

(51) Int. Cl. B60G 23/00

(52) U.S. Cl. 701/37; 280/5.515

(57) ABSTRACT

An electronically-controlled suspension apparatus includes a first sensing device for detecting a vertical acceleration of a vehicle body; a second sensing device for detecting vertical movements of a vehicle body relative to a wheel axle; and a controller for obtaining a vertical speed of the vehicle body by using the vertical acceleration detected by the first sensing device, obtaining a damper speed of a variable damper by using the vertical movements detected by the second sensing device, calculating a target damping force by using the vertical speed of the vehicle body and the damper speed, and determining a control command value by using the target damping force. The control command value is transmitted from the controller to the actuator of the variable damper to change damping force characteristics of the variable damper.

### FIELD OF THE INVENTION

The present invention relates to an electronically-controlled suspension apparatus and damping force control method; and more particularly, to an electronically-controlled suspension apparatus and damping force control method, which is capable of improving ride comfort and steering stability of a vehicle by controlling a damping force of a variable damper using not only a vertical speed of a vehicle body but also a damper speed of the variable damper.

### BACKGROUND OF THE INVENTION

Referring to FIG. 1, there is presented a block diagram of a conventional electronically-controlled suspension apparatus. FIG. 2 displays graphs indicating a vertical speed of a vehicle body varying with time and a damper speed varying with time, respectively.

As shown in FIG. 1, the conventional electronically-controlled suspension apparatus includes a variable damper 4 installed between a vehicle body 1 and a wheel 2 (or wheel axle). A spring 3 is connected in parallel to the variable damper 4 at a location between the vehicle body 1 and the wheel 2, so that the spring 3 as well as the variable damper 4 supports the vehicle body 1. The conventional electronically-controlled suspension apparatus includes a road surface condition detector 5 mounted to the vehicle body 1 to provide a controller 6 with a piece of information about judging road surface conditions. The road surface condition detector 5 is generally constituted by a vertical acceleration sensor for detecting a vertical acceleration of the vehicle body 1 and generating a vertical acceleration signal α. The piece of information for judging road surface conditions, for example, irregularity or roughness of a road surface, can be obtained by using amplitudes and frequencies of the vertical acceleration signal α generated from the vertical acceleration sensor. The vertical acceleration signal α generated from the road surface condition detector 5 is transmitted to the controller 6 and applied to an internal control algorithm of the controller 6, so that it is converted into a vehicle body vertical speed signal and the controller 6 generates a damping force control signal suitable for current driving conditions of the vehicle by using the vehicle body vertical speed signal. In FIG. 1, only one variable damper 4 and only one spring 3 and only one wheel 2 are shown for the convenience of description although four variable dampers 4 and four springs 3 are mounted in a vehicle in correspondence to four wheels 2.

The variable damper 4 is provided with an actuator 7 (a changing mechanism for changing damping characteristics of the variable damper 4 in response to the damping force control signal), such as a solenoid valve or a step motor, and has more than one damping force characteristic curve. The damping force characteristic curves of the damper 4 can be switched in a plurality of steps or continuously by operating the actuator 7. The actuator 7 is operated according to the damping force control signal from the controller 6. Therefore, the variable damper 4 generates damping force according to the damping force control signal, so that it suppresses vibration of the vehicle body to improve ride comfort, and also suppresses variation of traction force of the vehicle to improve steering stability of the vehicle.

As mentioned above, the conventional electronically-controlled suspension apparatus controls the damping force of the variable damper 4 on the basis of (or in proportion to) a vertical speed of the vehicle body calculated by using the vertical acceleration signal α generated from the vertical acceleration sensor constituting the road surface condition detector 5.

The damping force characteristics (or the selection of damping force characteristic curve) of the variable damper 4 are changed with the vertical acceleration signal α (i.e., the vertical speed of the vehicle body), but the damping force of the variable damper 4 is determined by the selected damping force characteristic curve of the variable damper 4 and a current damper speed of the variable damper. Moreover, the conventional electronically-controlled suspension apparatus, which controls the damping force in proportion to the vertical speed of the vehicle body, may have a high level of the vertical speed of the vehicle body even when the damper speed is close to zero as shown in FIG. 2. In such a case, it generates a damping force control signal for obtaining a high level of the damping force. And if the magnitude (or absolute value) of the damper speed is increased, the damping force is abruptly changed, resulting in ride comfort deterioration.

Further, if a phase of the damper speed is opposed to that of a target damping force so that a negative (−) damping coefficient is required, the damping force may become unnecessarily hard due to a time delay generated during signal processing or a slow response time of an actuator, resulting in ride comfort deterioration.

### SUMMARY OF THE INVENTION

It is, therefore, an object of the present invention is to provide an electronically-controlled suspension apparatus and damping force control method, which is capable of improving ride comfort and steering stability of a vehicle by using not only a vertical speed of a vehicle body but also a damper speed of a variable damper.

In accordance with one aspect of the present invention, there is provide an electronically-controlled suspension apparatus, which has a variable damper installed between a vehicle body and a wheel axle and provided with an actuator, the apparatus including: a first sensing device for detecting a vertical acceleration of the vehicle body; a second sensing device for detecting vertical movements of the vehicle body relative to the wheel axle; and a controller for obtaining a vertical speed of the vehicle body by using the vertical acceleration detected by the first sensing device, obtaining a damper speed of the variable damper by using the vertical movements detected by the second sensing device, calculating a target damping force by using the vertical speed of the vehicle body and the damper speed, and determining a control command value by using the target damping force, wherein the control command value is transmitted from the controller to the actuator of the variable damper to change damping force characteristics of the variable damper.

In accordance with another aspect of the present invention, there is provided an electronically-controlled suspension apparatus which has a variable damper installed between a vehicle body and a wheel axle and provided with an actuator, the apparatus including: a vertical acceleration sensing device for detecting a vertical acceleration of the vehicle body; a wheel axle acceleration sensing device for detecting a vertical acceleration of the wheel axle; and a controller for obtaining a vertical speed of the vehicle body and a vertical speed of the wheel axle by integrating the vertical acceleration of the vehicle body and the vertical acceleration of the wheel axle, calculating a damper speed of the variable damper by using the vertical speed of the vehicle body and the vertical speed of the wheel axle, calculating a target damping force by using the damper speed and the vertical speed of the vehicle body, and determining a control command value by using the target damping force, wherein the control command value is transmitted to the actuator of the variable damper to change damping force characteristics of the variable damper.

In accordance with still another aspect of the present invention, there is provided a damping force control method of an electronically-controlled suspension apparatus which has a variable damper installed between a vehicle body and a wheel axle and provided with an actuator, a first sensing device for detecting a vertical acceleration of the vehicle body, a second sensing device for detecting vertical movements of the vehicle body relative to the wheel axle, and which stores a soft damping force value and a maximum damping force value of the variable damper, the method including the steps of: calculating a vertical speed of the vehicle body by using the vertical acceleration detected by the first sensing device, and a damper speed of the variable damper by using the vertical movements detected by the second sensing device; calculating a target damping force by using the damper speed and the vertical speed of the vehicle body; determining whether a product of the target damping force and the damper speed is greater than 0; if the product of the target damping force and the damper speed is greater than 0, determining a first control command value in proportion to the target damping force and transmitting the determined first control command value to the actuator of the variable damper to change damping force characteristics of the variable damper; and if the product of the target damping force and the damper speed is equal to or less than 0, determining a second control command value for controlling the variable damper to be in a soft mode and transmitting the second control command value to the actuator of the variable damper.

In accordance with still another aspect of the invention, there is provided a damping force control method of an electronically-controlled suspension apparatus which has a variable damper installed between a vehicle body and a wheel axle and provided with an actuator, a vertical acceleration sensing device for detecting a vertical acceleration of the vehicle body and a wheel axle acceleration sensing device for detecting a vertical acceleration of the wheel axle, and which stores a soft damping force value and a maximum damping force value of the variable damper, the method including the steps of: calculating a vertical speed of the vehicle body and a vertical speed of the wheel axle by using the vertical acceleration of the vehicle body and the vertical acceleration of the wheel axle; calculating a damper speed of the variable damper by using the vertical speed of the vehicle body and the vertical speed of the wheel axle; calculating a target damping force by using the damper speed and the vertical speed of the vehicle body; determining whether a product of the target damping force and the damper speed is greater than 0; if the product of the target damping force and the damper speed is greater than 0, determining a first control command value in proportion to the target damping force and transmitting the determined first control command value to the actuator of the variable damper to change damping force characteristics of the variable damper; and if the product of the target damping force and the damper speed is equal to or less than 0, determining a second control command value for controlling the variable damper to be in a soft mode and transmitting the second control command value to the actuator.

### BRIEF DESCRIPTION OF THE DRAWINGS

The above objects and other features of the present invention will become apparent from the following description of the preferred embodiment given in conjunction with the accompanying drawings, in which:

FIG. 1 is a block diagram of a conventional electronically-controlled suspension apparatus;

FIG. 2 displays graphs illustrating a vertical speed of the vehicle body varying with time and a damper speed varying with time;

FIG. 3 presents a block diagram of an electronically-controlled suspension apparatus in accordance with a first preferred embodiment of the present invention;

FIG. 4 sets forth a plurality of damping force characteristic curves of a variable damper in damper speed-damping force coordinates; and

FIG. 5 illustrates a block diagram of an electronically-controlled suspension apparatus in accordance with a second preferred embodiment of the present invention.

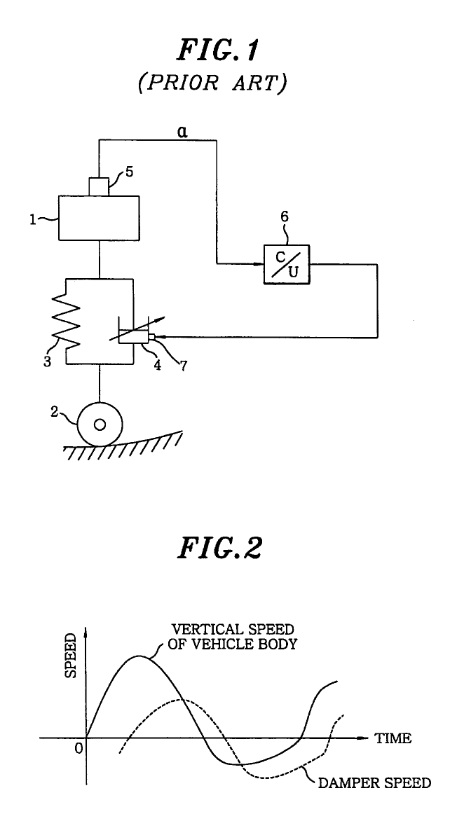

### DETAILED DESCRIPTION OF THE PREFERRED EMBODIMENTS

Now, preferred embodiments of the present invention will be described in detail with reference to the accompanying drawings.

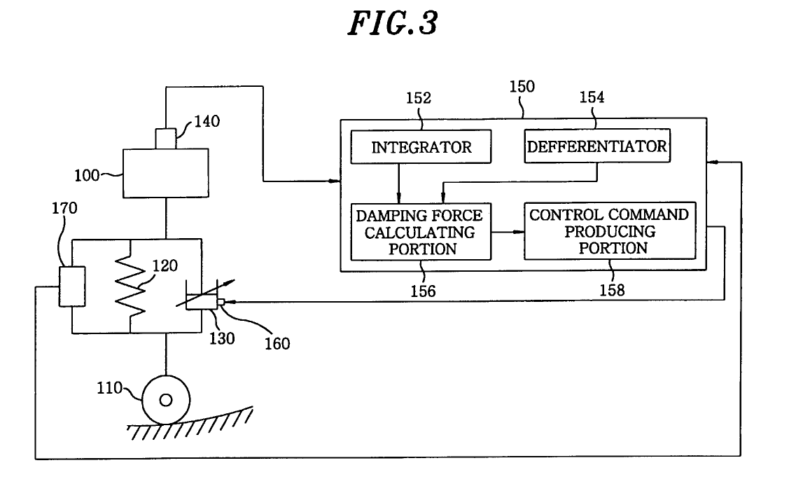

FIG. 3 is a block diagram of an electronically-controlled suspension apparatus in accordance with a first preferred embodiment of the present invention.

As shown in FIG. 3, the electronically-controlled suspension apparatus of the present invention includes a variable damper 130 installed between a vehicle body 100 and a wheel 110 (or wheel axle); and a second sensing device 170 for detecting vertical movements in up-and-down directions of the vehicle body 100 relative to the wheel 110, and generating a vehicle height signal indicating the detected vertical movements. A spring 120 is connected in parallel to the variable damper 130 and the second sensing device 170 at a location between the vehicle body 100 and the wheel 110, so that the spring 120 as well as the variable damper 130 supports the vehicle body 100. In FIG. 3, only one variable damper 130, only one second sensing device 170, only one spring 120 and only one wheel 110 are shown for the convenience of description although four variable dampers 130, four second sensing devices 170 and four springs 120 are mounted in a vehicle in correspondence to four wheels 2, respectively.

Further, the electronically-controlled suspension apparatus of the present invention includes a first sensing device 140 mounted to the vehicle body 100 and a controller 150. The first sensing device 140 detects a vertical acceleration of the vehicle body 100, and generates a vehicle body vertical acceleration signal indicating the detected vertical acceleration of the vehicle body 100. The controller 150 generates a control command value U for controlling a damping force of the variable damper 130 by using the vehicle body vertical acceleration signal generated from the first sensing device 140 and the vehicle height signal generated from the second sensing device 170.

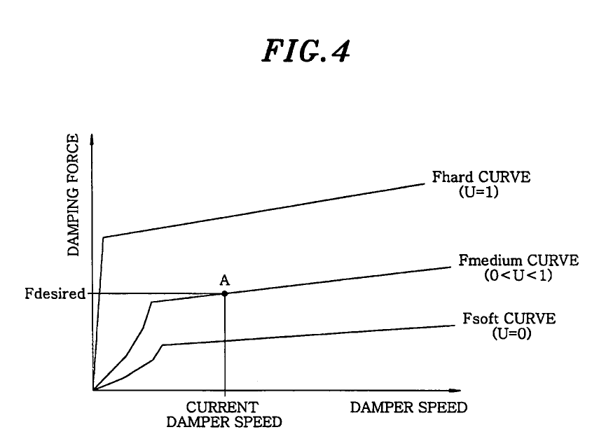

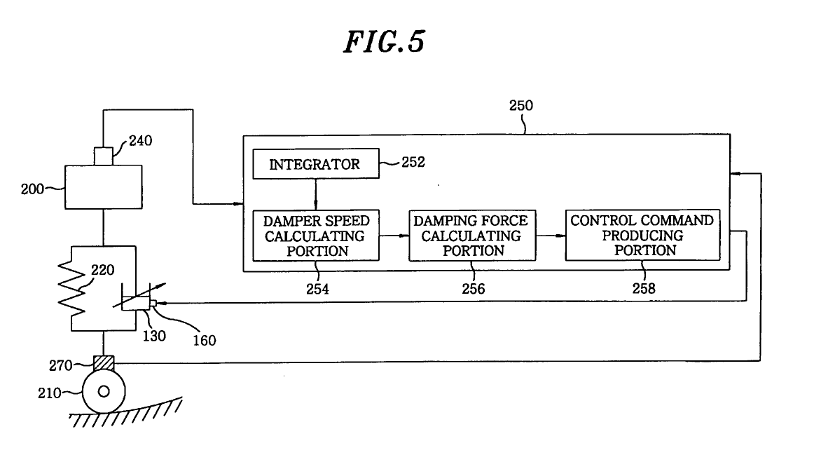

The variable damper 130 includes an actuator 160 which operates in response to the control command value U generated from the controller 150, and the damping force characteristics of the variable damper 130 are changed by the operation of the actuator 160. As shown in FIG. 4, the variable damper 130 has a plurality of damping force characteristic curves. Such damping force characteristic curves may be ones continuously existing between two curves F_{soft} and F_{hard}, or may be a plurality of predetermined distinct curves such as F_{soft}, F_{medium} and F_{hard}. If the control command value U is transmitted from the controller 150 to the actuator 160 of the variable damper 130, the actuator 160 is operated according to the control command value U, so that one of the damping force characteristic curves corresponding to the control command value U is set to the variable damper 130.

The first sensing device 140 is constituted by a vertical acceleration sensor, which detects the vertical acceleration of the vehicle body 100 and generates the vehicle body vertical acceleration signal indicating the detected vertical acceleration of the vehicle body 100. The vehicle body vertical acceleration signal is supplied to the controller 150. The second sensing device 170 installed between the vehicle body 100 and the wheel 110 is constituted by a vehicle height sensor, which detects vertical movements of the vehicle body 100 relative to the wheel 110 (or wheel axle) and generates the vehicle height signal indicating the detected vertical movements of the vehicle body 100 relative to the wheel 110. The vertical height signal generated from the second sensing device 170 is supplied to the controller 150.

The controller 150 includes an integrator 152 for integrating the vehicle body vertical acceleration signal received from the first sensing device 140 to calculate a vertical speed Zs of the vehicle body; a differentiator 154 for differentiating the vehicle height signal received from the second sensing device 170 to calculate a vehicle height speed; a damping force calculating portion 156 for calculating a target damping force F_{desired} by using the vertical speed Zs of the vehicle body received from the integrator 152 and the vehicle height speed (i.e., a damper speed Zu of the variable damper 130) received from the differentiator 154; and a control command producing portion 158 for determining the control command value U corresponding to the target damping force F_{desired}, and transmitting the determined control command value U to the actuator 160 of the variable damper 130. As mentioned above, the controller 150 uses the vehicle height speed as the damper speed Zu, and stores a soft damping force value F_{soft} and a maximum damping force value Fₘₐₓ, which are needed to calculate the control command value U. In this case, the soft damping force value F_{soft} is one which is used when the variable damper 130 is controlled to be in a soft mode.

The damping force calculating portion 156 calculates the target damping force F_{desired} using the following equation:
F_{desired}=K1×Zs+K2×Zu Eq. 1
where K1 and K2 are predetermined gain values and stored in the damping force calculating portion 156.

After the target damping force F_{desired} is calculated by the damping force calculating portion 156, the control command producing portion 158 included in the controller 150 determines whether the target damping force F_{desired} can be generated by a reaction force of the variable damper 130. In other words, the control command producing portion 158 determines whether the product of the target damping force F_{desired} and the damper speed Zu is greater than 0. If the product of the target damping force F_{desired} and the damper speed Zu is greater than 0, the control command producing portion 158 determines the control command value U by using the following equation:
U=(F_{desired}−F_{soft})/(Fₘₐₓ−F_{soft}) Eq. 2

Meanwhile, if the product of the target damping force F_{desired} and the damper speed Zu is equal to or less than 0, the control command producing portion 158 determines the control command value U to be 0.

If the control command value U is determined to be 0, the actuator 160 is controlled to allow the damping force characteristic curve F_{soft} in FIG. 4 to be set to the variable damper 130. If the control command value U is determined to be in the range between 0 and 1, the actuator 160 is controlled to allow the damping force characteristic curve F_{medium} in FIG. 4 to be set to the variable damper 130. Also, if the control command value U is determined to be 1, the actuator 160 is controlled to allow the damping force characteristic curve F_{hard} in FIG. 4 to be set to the variable damper 130.

FIG. 5 is a block diagram of an electronically-controlled suspension apparatus in accordance with a second preferred embodiment of the present invention.

As shown in FIG. 5, the electronically-controlled suspension apparatus in accordance with the second preferred embodiment of the present invention obtains a damper speed of the variable damper 130 by employing a wheel axle acceleration sensing device 270 mounted to a wheel axle of a wheel 210 to detect a vertical acceleration of the wheel axle, instead of the second sensing device 170 (i.e., a vehicle height sensor) of the above-mentioned electronically-controlled suspension apparatus of FIG. 3.

The controller 250 includes an integrator 252 for integrating a vertical acceleration of the vehicle body 200 generated from a vertical acceleration sensing device 240 constituted by a vertical acceleration sensor so as to obtain a vertical speed Zs of the vehicle body 200, and integrating the vertical acceleration of the wheel axle detected by the wheel axle acceleration sensing device 270 so as to obtain a vertical speed Zg of the wheel axle; a damper speed calculating portion 254 for calculating a damper speed Zu by using the vertical speed Zg of the wheel axle and the vertical speed Zs of the vehicle body from the integrator 252; a damping force calculating portion 256 for calculating a target damping force F_{desired} by using the damper speed Zu and the vertical speed Zs of the vehicle; and a control command producing portion 258 for determining a control command value U by using the target damping force F_{desired}, and transmitting the determined control command value U to the actuator 160 of the variable damper 130.

The damper speed calculating portion 254 calculates a damper speed Zu by using a difference between the vertical speed Zs of the vehicle body 200 and the vertical speed Zg of the wheel axle. The damping force calculating portion 256 calculates the target damping force F_{desired} by using the following equation:

$$\begin{matrix}{F}_{desired} = K1 \times Zs + K2 \times ( Zs - Zg ) \\ = K1 \times Zs + K2 \times Zu\end{matrix} \qquad Eq . 3$$

where K1 and K2 are predetermined gain values and stored in the damping force calculating portion 256.

After the target damping force F_{desired} is calculated by the damping force calculating portion 256, the control command producing portion 258 included in the controller 250 determines whether the target damping force F_{desired} can be generated by a reaction force of the variable damper 130. In other words, the control command producing portion 258 determines whether the product of the target damping force F_{desired} and the damper speed Zu is greater than 0. If the product of the target damping force F_{desired} and the damper speed Zu is greater than 0, the control command producing portion 258 determines the control command value U by using the above-mentioned Eq. 2, wherein a resultant value calculated by the above-mentioned Eq. 3 is used as the target damping force F_{desired}. Meanwhile, if the product of the target damping force F_{desired} and the damper speed Zu is equal to or less than 0, the control command producing portion 258 determines the control command value U to be 0.

If the control command value U is determined to be 0, the actuator 160 is controlled to allow the damping force characteristic curve F_{soft} in FIG. 4 to be set to the variable damper 130. If the control command value U is determined to be in the range between 0 and 1, the actuator 160 is controlled to allow the damping force characteristic curve F_{medium} in FIG. 4 to be set to the variable damper 130. Also, if the control command value U is determined to be 1, the actuator 160 is controlled to allow the damping force characteristic curve F_{hard} in FIG. 4 to be set to the variable damper 130.

According to the above-mentioned preferred embodiments of the present invention, the control command value U is determined by using Eq. 2 if the product of the target damping force F_{desired} and the damper speed Zu is greater than 0. There is also proposed another method of determining the control command value U, in which the control command value U is determined to be one predetermined value corresponding to one of damping force characteristic curves passing an intersection point A (see FIG. 4) between a horizontal line indicating the target damping force F_{desired} and a vertical line indicating a current damper speed of the variable damper 130 in damper speed-damping force coordinates. This method of determining the control command value U can provide the actuator 160 with the control command value U more suitable to current driving conditions of the vehicle.

As described above, in the electronically-controlled suspension apparatus and damping force control method in accordance with the present invention, since a damping force of a variable damper is controlled by using not only a vertical speed of the vehicle body but also a damper speed of the variable damper, the damping force of the variable damper can be controlled more appropriately in response to vehicle driving conditions, thus improving ride comfort and steering stability of a vehicle.

While the invention has been shown and described with respect to the preferred embodiments, it will be understood by those skilled in the art that various changes and modifications may be made without departing from the spirit and scope of the invention as defined in the following claims.

1. An electronically-controlled suspension apparatus, which has a variable damper installed between a vehicle body and a wheel axle and provided with an actuator, the apparatus comprising:
a first sensing device for detecting a vertical acceleration of the vehicle body;
a second sensing device for detecting vertical movements of the vehicle body relative to the wheel axle; and
a controller for obtaining a vertical speed of the vehicle body by using the vertical acceleration detected by the first sensing device, obtaining a damper speed of the variable damper by using the vertical movements detected by the second sensing device, calculating a target damping force by using the vertical speed of the vehicle body and the damper speed, and determining a control command value by using the target damping force,
wherein the control command value is transmitted from the controller to the actuator of the variable damper to change damping force characteristics of the variable damper.

2. The apparatus of claim 1, wherein the controller stores a soft damping force value and a maximum damping force value of the variable damper, and the control command value is determined by using a following equation:
U=(F_{desired}−F_{soft})/(Fₘₐₓ−F_{soft})
where U represents the control command value; F_{desired}, the target damping force; Fₘₐₓ, the maximum damping force value; and F_{soft}, the soft damping force value.

3. The apparatus of claim 1, wherein the controller determines the control command value to be a predetermined value corresponding to one of damping force characteristic curves of the variable damper, the one of the damping force characteristic curves passing an intersection point between a horizontal line indicating the target damping force and a vertical line indicating a current damper speed of the variable damper in damper speed-damping force coordinates.

4. An electronically-controlled suspension apparatus which has a variable damper installed between a vehicle body and a wheel axle and provided with an actuator, the apparatus comprising:
a vertical acceleration sensing device for detecting a vertical acceleration of the vehicle body;
a wheel axle acceleration sensing device for detecting a vertical acceleration of the wheel axle; and
a controller for obtaining a vertical speed of the vehicle body and a vertical speed of the wheel axle by integrating the vertical acceleration of the vehicle body and the vertical acceleration of the wheel axle, calculating a damper speed of the variable damper by using the vertical speed of the vehicle body and the vertical speed of the wheel axle, calculating a target damping force by using the damper speed and the vertical speed of the vehicle body, and determining a control command value by using the target damping force,
wherein the control command value is transmitted to the actuator of the variable damper to change damping force characteristics of the variable damper.

5. The apparatus of claim 4, wherein the controller stores a soft damping force value and a maximum damping force value of the variable damper, and the control command value is determined by the following equation:
U=(F_{desired}−F_{soft})/(Fₘₐₓ−F_{soft})
where U represents the control command value; F_{desired}, the target damping force; Fₘₐₓ, the maximum damping force value; and F_{soft}, the soft damping force value.

6. The apparatus of claim 4, wherein the controller determines the control command value to be a predetermined value corresponding to one of damping force characteristic curves of the variable damper, the one of the damping force characteristic curves passing an intersection point between a horizontal line indicating the target damping force and a vertical line indicating a current damper speed of the variable damper in damper speed-damping force coordinates.

7. A damping force control method of an electronically-controlled suspension apparatus which has a variable damper installed between a vehicle body and a wheel axle and provided with an actuator, a first sensing device for detecting a vertical acceleration of the vehicle body, a second sensing device for detecting vertical movements of the vehicle body relative to the wheel axle, and which stores a soft damping force value and a maximum damping force value of the variable damper, the method comprising the steps of:
calculating a vertical speed of the vehicle body by using the vertical acceleration detected by the first sensing device, and a damper speed of the variable damper by using the vertical movements detected by the second sensing device;
calculating a target damping force by using the damper speed and the vertical speed of the vehicle body;
determining whether a product of the target damping force and the damper speed is greater than 0;
if the product of the target damping force and the damper speed is greater than 0, determining a first control command value in proportion to the target damping force and transmitting the determined first control command value to the actuator of the variable damper to change damping force characteristics of the variable damper; and
if the product of the target damping force and the damper speed is equal to or less than 0, determining a second control command value for controlling the variable damper to be in a soft mode and transmitting the second control command value to the actuator of the variable damper.

8. The method of claim 7, wherein the target damping force is calculated by a following equation:
F_{desired}=K1×Zs+K2×Zu
where F_{desired} represents the target damping force; K1 and K2 represent predetermined gain values; Zs represents the vertical speed of the vehicle body; and Zu, the damper speed of the variable damper.

9. The method of claim 7, wherein the first control command value is determined by using a following equation:
U=(F_{desired}−F_{soft})/(Fₘₐₓ−F_{soft})
where U represents the first control command value; F_{desired}, the target damping force; Fₘₐₓ, the maximum damping force value; and F_{soft}, the soft damping force value.

10. The method of claim 7, wherein the first control command value is determined to be a predetermined value corresponding to one of damping force characteristic curves of the variable damper, the one of the damping force characteristic curves passing an intersection point between a horizontal line indicating the target damping force and a vertical line indicating a current damper speed of the variable damper in damper speed-damping force coordinates.

11. A damping force control method of an electronically-controlled suspension apparatus which has a variable damper installed between a vehicle body and a wheel axle and provided with an actuator, a vertical acceleration sensing device for detecting a vertical acceleration of the vehicle body and a wheel axle acceleration sensing device for detecting a vertical acceleration of the wheel axle, and which stores a soft damping force value and a maximum damping force value of the variable damper, the method comprising the steps of:
calculating a vertical speed of the vehicle body and a vertical speed of the wheel axle by using the vertical acceleration of the vehicle body and the vertical acceleration of the wheel axle;
calculating a damper speed of the variable damper by using the vertical speed of the vehicle body and the vertical speed of the wheel axle;
calculating a target damping force by using the damper speed and the vertical speed of the vehicle body;
determining whether a product of the target damping force and the damper speed is greater than 0;
if the product of the target damping force and the damper speed is greater than 0, determining a first control command value in proportion to the target damping force and transmitting the determined first control command value to the actuator of the variable damper to change damping force characteristics of the variable damper; and
if the product of the target damping force and the damper speed is equal to or less than 0, determining a second control command value for controlling the variable damper to be in a soft mode and transmitting the second control command value to the actuator.

12. The method of claim 11, wherein the target damping force F_{desired} is calculated by a following equation:
F_{desired}=K1×Zs+K2×Zu
where F_{desired} represents the target damping force; K1 and K2 represent predetermined gain values; Zs represents the vertical speed of the vehicle body; and Zu, the damper speed of the variable damper.

13. The method of claim 11, wherein the first control command value U is determined by using a following equation:
U=(F_{desired}−F_{soft})/(Fₘₐₓ−F_{soft})
where U represents the first control command value; F_{desired}, the target damping force; Fₘₐₓ, the maximum damping force value; and F_{soft}, the soft damping force value.

14. The method of claim 11, wherein the first control command value is determined to be a predetermined value corresponding to one of damping force characteristic curves of the variable damper, the one of the damping force characteristic curves passing an intersection point between a horizontal line indicating the target damping force and a vertical line indicating a current damper speed of the variable damper in damper speed-damping force coordinates.
